(19) United States
(12) Patent Application Publication
(10) Pub. No.: US 2003/0169875 A1
(43) Pub. Date: Sep. 11, 2003

(54) On-chip compensation scheme for bridged tap lines in ADSL hybrid

(75) Inventors: Sang-Soo Lee, Cupertino, CA (US); Hiroshi Kimura, San Jose, CA (US); Ju Hi John Hong, San Jose, CA (US); Jin-Der Wang, San Jose, CA (US); John P. DeCelles, JR., Campbell, CA (US); Bryan S. Rowan, San Jose, CA (US)

Correspondence Address: LSI LOGIC CORPORATION, 1621 BARBER LANE, MS D-106, LEGAL DEPARTMENT, MILPITAS, CA, 95035, US

(73) Assignee: LSI LOGIC CORPORATION

(21) Appl. No.: 10/197,667

(22) Filed: Jul. 17, 2002

Related U.S. Application Data
(60) Provisional application No. 60/363,203, filed on Mar. 7, 2002.

(51) Int. Cl. H04M 1/00; H04M 9/00

(52) U.S. Cl. 379/399.01

(57) ABSTRACT

A modem generally comprising an analog front end circuit, a hybrid circuit, and a variable impedance element. The hybrid circuit may be configured to couple the analog front end circuit to a transmission line. The variable impedance may be disposed within the analog front end circuit and connected to the hybrid circuit to trim an echo cancelling function of the hybrid circuit.

This application claims the benefit of U.S. Provisional Application No. 60/363,203, filed Mar. 7, 2002 which is hereby incorporated by reference in its entirety.

### FIELD OF THE INVENTION

The present invention relates to a model generally and, more particularly, to on-chip compensation scheme for bridged tap lines in an asymmetrical digital subscriber line hybrid circuit.

### BACKGROUND OF THE INVENTION

Conventional modems operating in accordance with an Asymmetrical Digital Subscriber Line (ADSL) standard commonly incorporate an echo cancelling hybrid circuit or hybrid circuit for short. The hybrid circuit combines a transmit signal with a receive signal in an ADSL transceiver so that a two-wire transmission line can be used for bidirectional data communication. The echo cancellation functionality is necessary to cancel an echo signal caused by a portion of the transmit signal appearing in the receive signal as noise. P Referring to FIG. 1, a block diagram of an example conventional line interface circuit 10 of an ADSL modem is shown. The conventional line interface circuit example is provided by T. Starr, J. M. Cioffi, and P. J. Silverman in, “Understanding Digital Subscriber Line Technology”, published by Prentice Hall, 1999. The line interface circuit 10 includes a line driver 12, a line receiver 14, and a hybrid circuit 16 connectable to a transmission line. The hybrid circuit 16 forms a bridge where the transmit signal through an echo path (i.e., through the right hand side impedance Zt) is balanced out by a properly scaled transmit signal of the opposite polarity through a direct path (i.e., through the left hand side impedance Zt). The design of such a hybrid circuit 16 is straightforward when the transmission line connected to the hybrid circuit 16 is a simple line with no bridged taps. However, if the transmission line has one or more bridged taps, a line impedance (i.e., Zline) of the transmission line as seen by the hybrid circuit 16 varies rapidly as a function of frequency depending on the location and the length of the bridged taps. It is thus difficult to design the hybrid circuit 16 to provide a good cancellation of the echo signal for transmission lines with arbitrary bridged taps. A common solution is to make the impedance Zref adjustable to compensate for variations in the actual line impedance Zline. Adjustments are made by several discrete switches (not shown) that switch resistors (not shown) in and out of the total impedance Zref.

Referring to FIG. 2, a topology of an example conventional test loop 18 with a bridged tap is shown. The conventional test loop example is provided by R. Brost and S. Aspell, editors in, “DSL Forum, Technical Report TR-048-ADSL Interoperability Test Plan”, published by the DSL Forum Testing & Interoperability Working Group, April, 2002. The conventional test loop 18 has a variable length bridged tap 20 at a fixed distance between an ADSL Termination Unit-Central Office (ATU-C) 22 and an ADSL Termination Unit-Remote (ATU-R) 24. For a transmission line with a bridged tap, the magnitude of the line impedance seen by the remote transceiver (ATU-R) 24 is smaller than for the transmission line without the bridged tap. A simple sub-optimum hybrid circuit 16 for a transmission line with a bridged tap can be designed by scaling down an opposite polarity transmit signal in the direct path.

### SUMMARY OF THE INVENTION

The present invention concerns a modem generally comprising an analog front end circuit, a hybrid circuit, and a variable impedance element. The hybrid circuit may be configured to couple the analog front end circuit to a transmission line. The variable impedance may be disposed within the analog front end circuit and connected to the hybrid circuit to trim an echo cancelling function of the hybrid circuit.

The objects, features and advantages of the present invention include providing an on-chip compensation scheme for bridged tap lines in an asymmetrical digital subscriber line hybrid circuit that may (i) simplify fabrication of a variable impedance element, (ii) minimize nonlinearity associated with CMOS switches and/or (iii) minimize tolerance variations associated with on-chip resistors.

### BRIEF DESCRIPTION OF THE DRAWINGS

These and other objects, features and advantages of the present invention will be apparent from the following detailed description and the appended claims and drawings in which:

FIG. 1 is a block diagram of an example conventional line interface circuit of an ADSL modem;

FIG. 2 is a topology of an example conventional test loop with a bridged tap;

FIG. 3 is a block diagram of an example line modem in accordance with a preferred embodiment of the present invention;

FIG. 4 is a block diagram of example implementations of a line interface circuit and a portion of an analog front end circuit;

FIG. 5 is a block diagram of a second example embodiment of the line interface circuit;

FIG. 6 is a block diagram of an example implementation of the variable impedance element; and

FIG. 7 is a graph of a variable impedance element value versus a bridged tap length.

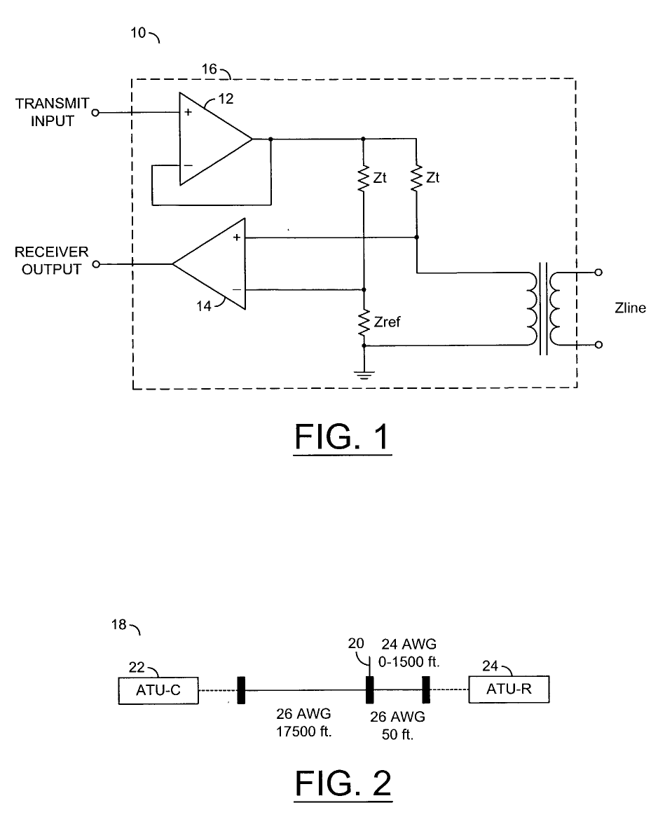

### DETAILED DESCRIPTION OF THE PREFERRED EMBODIMENTS

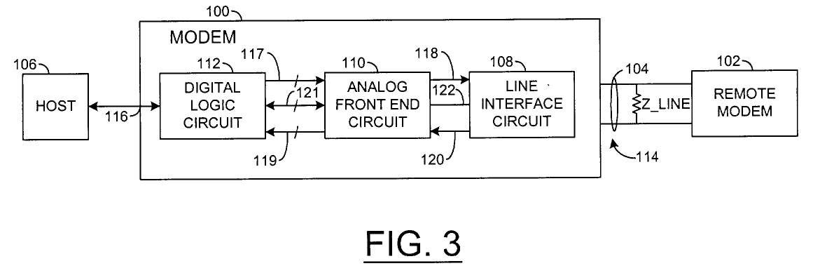

Referring to FIG. 3, a block diagram of a modem 100 is shown in accordance with a preferred embodiment of the present invention. The invention generally simplifies design and fabrication by implementing a variable impedance element in a monolithic integrated circuit instead of in discrete elements. The present invention may also reduce nonlinear effects conventionally associated with the on-chip CMOS switches and tolerance effects associated with the on-chip resistors. The present invention may be applied to a Customer Premises Equipment (CPE) modem and/or a Central Office (CO) modem.

The modem 100 may be connected to a remote modem 102 through a differential transmission line 104 and connected to a host 106. In one embodiment, the modem 100 may operate as a Customer Premises Equipment (CPE) modem while the remote modem 102 operate as a Central Office (CO) modem. In another embodiment, the modem 100 may operate as the CO modem and the remote modem 102 may operate as the CPE modem. The transmission line 104 may have a characteristic impedance (e.g., Z_LINE).

The modem 100 generally comprises a line interface circuit 108, an analog front end circuit 110, and a digital logic circuit 112. An interface 114 may be provided between the modem 100 and the transmission line 104. Another interface 116 may be provided between the modem 100 and the host 106. The digital logic circuit 112 generally provides for communications between the host 106 and the modem 100 on a transmit interface 117, a receive interface 119 and a control and/or management interface 121. The analog front end circuit 110 generally provides for conversion between a digital domain of the digital logic circuit 112 and an analog domain of the transmission line 104. The line interface circuit 108 generally provides multiplexing and demultiplexing between the transmission line 104 and (i) transmit interface 118 and (ii) a separate receive interface 120 of the analog front end circuit 110. An interface 122 may be provided between the analog front end circuit 110 and the line interface circuit 108 to allow the line interface circuit 108 to be trimmed from the analog front end circuit 110. Trimming may be controlled by means of the control/management interface 121 from the digital logic circuit 112.

In one embodiment, the modem 100 may be designed as an Asymmetric Digital Subscriber Line (ADSL) modem using discrete multi-tone signals. In other embodiments, the modem 100 may be implemented as a Digital Subscriber Line (DSL) modem, a High data rate Digital Subscriber Line (HDSL) modem, a Very high data rate Digital Subscriber Line (VDSL) modem, a G.Lite ADSL modem, or the like. The modem 100 may be implemented in compliance with other modem standards, such as G.dmt.bis, to meet the design criteria of a particular application.

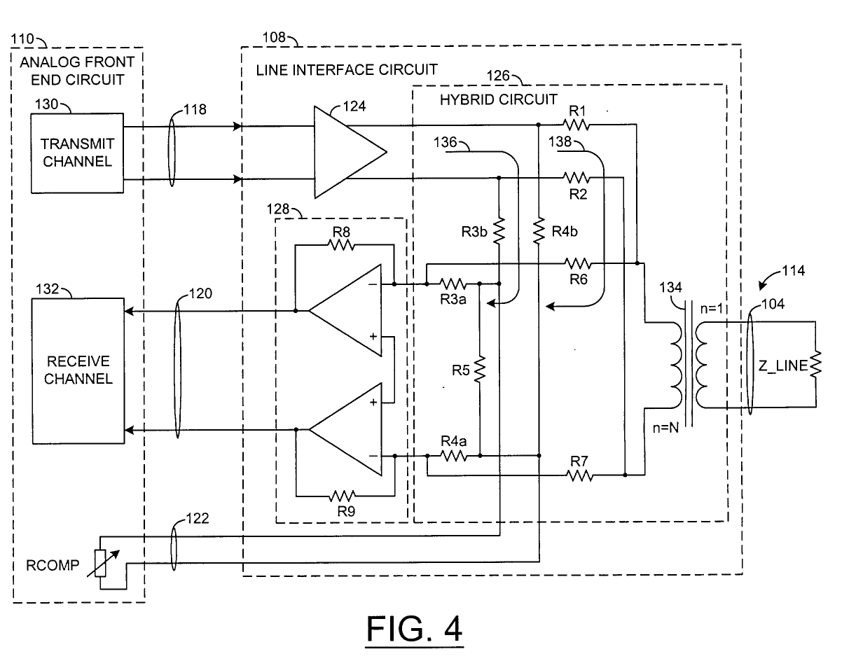

Referring to FIG. 4, a block diagram of example implementations of the line interface circuit 108 and a portion of the analog front end circuit 110 is shown. The line interface circuit 108 generally comprises a line driver circuit 124, an echo cancelling hybrid circuit 126, and a line receiver circuit 128. The echo cancelling hybrid circuit 126, or hybrid circuit for short, may have the interface 114 for connecting to the differential transmission line 104. The line driver circuit 124 may have the interface 118 for receiving the transmit signal from the analog front end circuit 110. The line receiver circuit 128 may have the interface 120 for transferring the receive signal to the analog front end circuit 110. The hybrid circuit 126 may also have the interface 122 for connecting to a variable impedance element (e.g., Rcomp).

The analog front end circuit 110 generally comprises a transmit channel 130, a receive channel 132, and the variable impedance element Rcomp. In one embodiment, the analog front end circuit 110 may be implemented as a monolithic integrated circuit. In another embodiment, the analog front end circuit 110 may be implemented as multiple components. In still another embodiment, the monolithic integrated circuit may include the line driver circuit 124 and the line receiver circuit 128 as part of the analog front end circuit 110. Programming of the variable impedance element Rcomp within the analog front end circuit 110 may trim or set an echo cancellation function provided by the hybrid circuit 126. Adjusting the variable impedance Rcomp to a particular value may optimize an ability of the hybrid circuit 126 to cancel an echo signal created by the transmit signal in the receive signal.

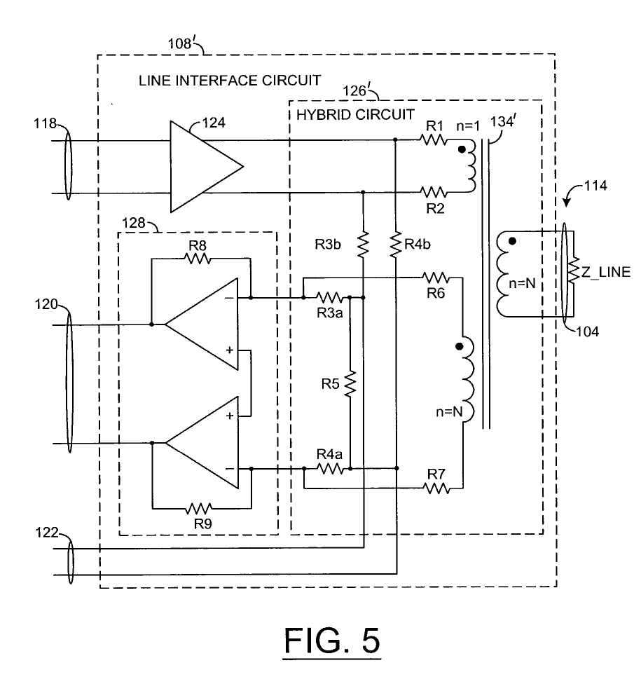

The hybrid circuit 126 generally comprises a transformer 134 and multiple impedance elements R1, R2, R3a, R3b, R4a, R4b, R5, R6, and R7. The transformer 134 may be implemented as a two winding transformer as shown, a three winding transformer (see FIG. 5), or a multiple winding transformer. Several pairs of the impedance elements, such as R1 and R2, R3a and R4a, R3b and R4b, and R6 and R7 may be matched devices having equal impedances. Each of the impedance elements R1-R7 may have a purely resistive value or a complex value having capacitive and/or inductive characteristics. The impedance element R5 may be an optional device that may be excluded from the hybrid circuit 126 in some designs. Designs incorporating the impedance element R5 generally implement R5 as a resistor having a value equal to or slightly greater than a highest anticipated value for the line impedance Z_LINE for long lines without bridged taps. In one embodiment, R5 may be implemented as a complex impedance comprising resistive and reactive elements.

The impedance elements R3a, R3b, R4a, R4b, R5, and Rcomp generally determine a direct path gain for the transmit signal along a direct path 136. The direct path 136 generally routes from the line driver circuit 124 to the line receiver circuit 128 external to the transformer 134. The impedance elements R1, R2, R6, R7, Z_LINE, and a turns ratio N:1 of the transformer 134 generally determine an echo path gain for the transmit signal along an echo path 138. The echo path 138 generally routes from the line driver circuit 124 to the line receiver circuit 128 through the transformer 134. Since the direct path gain may be negative as compared to the echo path gain, the transmit signal flowing along the direct path 136 may cancel some or all of the transmit signal flowing along the echo path 138.

While the transmission line 104 has one or more bridged taps and/or a non-ideal line impedance Z_LINE, the direct path gain may be adjusted by adding the variable impedance element Rcomp in parallel to the impedance element R5. The value of the variable impedance element Rcomp may be adjusted to account for a variety of bridged tap lengths to maximize a data rate in the receive signal.

Referring to FIG. 5, a block diagram of a second example embodiment of the line interface circuit 108 is shown. The line interface circuit 108′ generally comprises the line driver circuit 124, a hybrid circuit 126′, and the line receiver circuit 128. The hybrid circuit 126′ may be implemented with a three-winding transformer 134′. The line driver circuit 124 may be connected to a first primary winding of the transformer 134′. A second primary winding of the transformer 134′ may be connected to the line receiver circuit 128. Finally, the secondary winding of the transformer 134′ may be connectable to the transmission line 104.

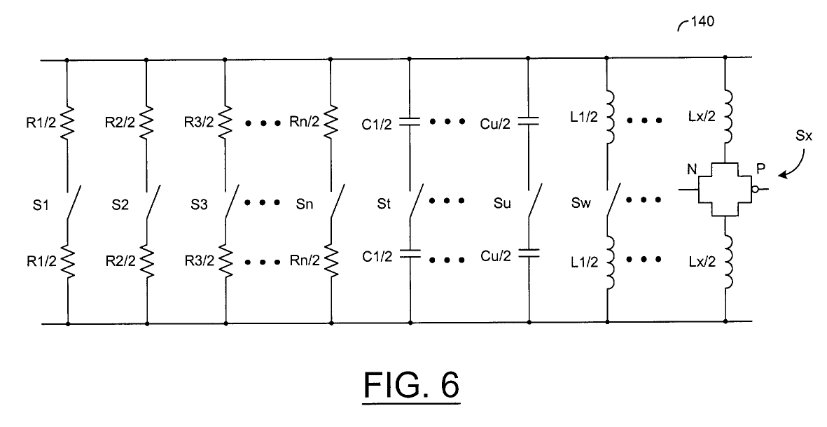

Referring to FIG. 6, a block diagram of an example implementation of the variable impedance element Rcomp is shown. The variable impedance element Rcomp generally comprises multiple resistor pairs R1 through Rn and multiple switches S1 through Sn. Optionally, the variable impedance element Rcomp may include one or more capacitor pairs C1 through Cu and associated switches St through Su. Furthermore, the variable impedance element Rcomp may optionally include one or more inductor pairs L1 through Lx and associated switches Sw through Sx. Each of the resistors R1-n, capacitors C1-u, and inductors L1-x may be arranged in a ladder 140 type configuration. Each rung of the ladder 140 arrangement may include a switch S as well as a resistor pair R, a capacitor pair C, or an inductor pair L.

In one embodiment, the switches S1-x may range in number from approximately sixteen to thirty-two switches. Larger or smaller numbers of switches may be implemented to meet the design criteria of a particular application. In general, each switch S1-x may be independently opened and closed. One or more switches S1-x may be in a closed state simultaneously. Furthermore, all of the switches S1-x may be in an open state simultaneously.

Each switch S1-x may be implemented as a transistor, multiple transistors, or other solid state switching device. In one embodiment, each switch S1-x may include an n-channel MOS transistor in parallel with a p-channel MOS transistor to form a CMOS pass gate. In another embodiment, bipolar, unijunction, and/or field effect transistors may be used to meet the design criteria of a particular application and fabrication of the analog front end circuit 110.

The variable impedance element Rcomp may be an integral part of the analog front end circuit 110. Integrating the variable impedance element Rcomp may simplify the overall implementation while generally overcoming difficulties associated with using on-chip resistors and CMOS switches instead of a conventional approach using discrete resistors and discrete relays. The on-chip CMOS switches S1-x generally have nonlinear impedance characteristics. The on-chip resistors R1-n generally have large tolerances. The nonlinear and large tolerance characteristics inherent in an integrated design may be overcome by implementing the parallel resistor ladder design.

In the ladder design, the CMOS switches S1-x may be placed in the middle of the resistors R1-n, capacitors C1-u, and inductors L1-x to minimize a voltage swing across the switches S1-x caused by the differential transmit and receive signals. For example, approximately half of the resistor R1 may be connected to a source node of the switch S1 and the other half of the resistor R1 may be connected to a drain node of the switch S1. The switch centered topology generally minimizes the CMOS switch nonlinearity. In addition, each impedance elemental resistor value may be designed to be much larger (e.g., at least ten times larger) than the CMOS switch nonlinear resistance while the CMOS switches S1-x are “closed” and generally operating in or near a linear region. The resulting CMOS switches S1-x generally require minimal area and yet may provide sufficient linearity. The CMOS switch linearity may make it possible to provide a large number of resistors R1-n and switch elements S1-n to cover an expected on-chip resistor tolerance and at the same time to obtain a required granularity without incurring excessive chip area penalty.

The resistor, capacitor, and/or inductor values may be determined recursively so that as the Rcomp value decreases, the switches S1-x may be closed starting from a particular side of the ladder or in any order. Thus while the impedance element Rcomp should have a large impedance value, all the switches S1-x may be open leaving the resistor R5 (if implemented in the hybrid circuit 126 and/or the analog front end circuit 110) to establish a maximum impedance value (e.g., 200 ohms). A minimum impedance value (e.g., twenty ohms) may be obtained when all the resistor associated switches S1-n are closed. A minimum granularity (e.g., ten ohms) for the variable impedance element Rcomp may be determined by opening or closing a single switch S1-x associated with a largest rung impedance. In typical applications for an ADSL remote transceiver, optimum resistive, capacitive, and/or inductive values may be determined during initial installation and stored in a nonvolatile memory, a handshake/initialization phase of each data transmission session, a user initiated training, and/or another comparable event.

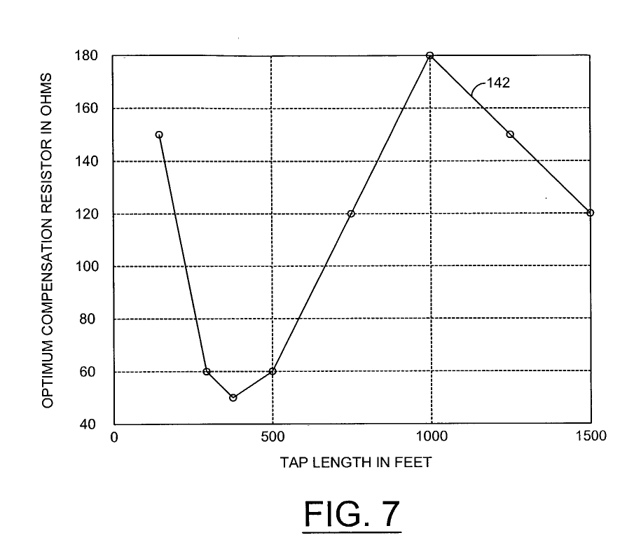

Referring to FIG. 7, a graph of a bridged tap length versus the impedance Rcomp (in parallel with R5) is shown. Each point on curve 142 generally represents an impedance value that may maximize a received data rate for a particular bridged tap length in a test loop. The curve 142 generally shows that the relationship between the optimum impedance and the bridged tap length may be rather complex.

The various signals of the present invention are generally “on” (e.g., a digital HIGH, or 1) or “off” (e.g., a digital LOW, or 0). However, the particular polarities of the on (e.g., asserted) and off (e.g., de-asserted) states of the signals may be adjusted (e.g., reversed) accordingly to meet the design criteria of a particular implementation. Additionally, inverters may be added to change a particular polarity of the signals. As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the spirit and scope of the invention.

1. A modem comprising:
an analog front end circuit;
a hybrid circuit configured to couple said analog front end circuit to a transmission line; and
a variable impedance disposed within said analog front end circuit and connected to said hybrid circuit to trim an echo cancelling function of said hybrid circuit.

2. The modem according to claim 1, wherein said hybrid circuit comprises a fixed impedance connected in parallel to said variable impedance.

3. The modem according to claim 1, wherein said variable impedance comprises a plurality of impedance elements selected among resistors, capacitors, and inductors.

4. The modem according to claim 3, wherein said variable impedance further comprises a plurality of switches connected to said impedance elements.

5. The modem according to claim 4, wherein said resistors and said switches are connected in a ladder arrangement.

6. The modem according to claim 5, wherein each rung of said ladder arrangement comprises one of said switches disposed between two of said impedance elements.

7. The modem according to claim 6, wherein said two impedance elements on each said rung have approximately equal values.

8. The modem according to claim 6, wherein each of said rungs has a different impedance value while said switches are closed.

9. The modem according to claim 1, wherein said variable impedance comprises:
a plurality of resistors; and
a plurality of solid state switches.

10. The modem according to claim 9, where said plurality of solid state switches comprises at least sixteen solid state switches.

11. A circuit comprising:
a transmit channel connectable to a line driver in a line interface circuit of a modem;
a receive channel connectable to a line receiver in said line interface circuit; and
a variable impedance connectable to said line interface circuit to trim an echo cancelling function of said line interface circuit.

12. The circuit according to claim 11, wherein said circuit comprises a monolithic integrated circuit.

13. The circuit according to claim 12, wherein said variable impedance comprises:
a plurality of resistors connectable in parallel; and
a plurality of switches connected to said resistors.

14. The circuit according to claim 13, wherein said resistors are formed as part of said monolithic integrated circuit.

15. The circuit according to claim 13, wherein said switches are a plurality of transistors formed as part of said monolithic integrated circuit.

16. The circuit according to claim 15, wherein each of said switches comprises a CMOS pass gate.

17. The circuit according to claim 13, wherein each said switch has a closed impedance less than that of said resistors directly connected to said switch.

18. The circuit according to claim 11, wherein said variable impedance further comprises a plurality of capacitors.

19. The circuit according to claim 18, wherein said variable impedance further comprises a plurality of inductors.

20. A modem comprising:
an analog front end circuit;
means for coupling said analog front end circuit to a transmission line; and
means for trimming an echo cancelling function of said means for coupling disposed within said analog front end circuit.
